(19) United States
(12) Patent Application Publication
(10) Pub. No.: US 2025/0373170 A1
(43) Pub. Date: Dec. 4, 2025

(54) CIRCUITS AND METHODS OF OPERATING HIGH SIDE SWITCHES IN SAFE OPERATING AREA IN SWITCHING REGULATORS

(71) Applicant: Navitas Semiconductor Limited, Dublin (IE)

(72) Inventors: Zhenxu ZHA, Shanghai (CN); Changhu YU, Shanghai (CN); Yinshi YU, Shanghai (CN)

(73) Assignee: Navitas Semiconductor Limited, Dublin (IE)

(21) Appl. No.: 19/227,195

(22) Filed: Jun. 3, 2025

(30) Foreign Application Priority Data
Jun. 3, 2024 (CN) 2024107110222

(51) Int. Cl. H02M 3/335; H02M 1/32

(52) U.S. Cl. CPC H02M 3/33571; H02M 1/32

(57) ABSTRACT

A circuit is disclosed. The circuit includes a transformer having a primary winding extending from a first terminal to a second terminal, a capacitor connected between the first terminal and an input terminal, a first switch having a first source terminal and a first drain terminal, the first drain terminal connected to the input terminal, a second switch having a second source terminal and a second drain terminal, the second drain terminal connected to the second terminal and a controller arranged to sense a voltage at the first terminal, compare the sensed voltage to a predetermined threshold, and control a state of the first switch such that when the sensed voltage exceeds the predetermined threshold, the state of the first switch is transitioned from a first on-state to a first off-state, from the first off-state to a second on-state and from the second on-state to a second off-state.

### CROSS REFERENCE TO RELATED APPLICATIONS

This application claims priority to China provisional patent application no. 2024107110222, for “PROTECTION FOR RESONANT TANK IN SWITCHING REG” filed on Jun. 3, 2024, which is hereby incorporated by reference in entirety for all purposes.

### FIELD

The described embodiments relate generally to power converters, and more particularly, the present embodiments relate to circuits and methods of operating high side switches in their safe operating area (SOA) in switching regulators.

### BACKGROUND

Electronic devices such as computers, servers and televisions, among others, employ one or more electrical power conversion circuits to convert one form of electrical energy to another. Some electrical power conversion circuits convert a high (or low) DC voltage to a lower (or higher) DC voltage using a circuit topology called DC-DC converter. As many electronic devices are sensitive to size and efficiency of the power conversion circuit, new power converters can provide relatively higher efficiency and lower size for the new electronic devices.

### SUMMARY

In some embodiments, a circuit is disclosed. The circuit includes a transformer having a primary winding magnetically coupled to a secondary winding, the primary winding extending from a first terminal to a second terminal; a capacitor connected between the first terminal and a power input terminal; a first switch having a first gate terminal, a first source terminal and a first drain terminal, the first drain terminal connected to the power input terminal; a second switch having a second gate terminal, a second source terminal and a second drain terminal, the second drain terminal connected to the second terminal and to the first source terminal; and a controller circuit connected to the first terminal and arranged to: sense a voltage at the first terminal; compare the sensed voltage to a predetermined threshold; and control a state of the first switch such that when the sensed voltage exceeds the predetermined threshold, the state of the first switch is transitioned from a first on-state to a first off-state, from the first off-state to a second on-state and from the second on-state to a second off-state.

In some embodiments, the controller circuit includes an overcurrent sensing circuit connected to an active discharge controller circuit.

In some embodiments, the capacitor is a first capacitor, where the overcurrent sensing circuit includes a second capacitor connected to a resistor.

In some embodiments, the second capacitor includes a first end and a second end, where the first end is connected to the first terminal and the second end is connected to the resistor.

In some embodiments, the controller circuit is further arranged to control the state of the first switch such that after transition from the second on-state to a second off-state, the first switch is transitioned from the second off-state to a third on-state and from the third on-state to a third off-state.

In some embodiments, a time duration of the second on-state is equal to a time duration of the third on-state.

In some embodiments, a method of operating a circuit is disclosed. The method includes providing a transformer having a primary winding magnetically coupled to a secondary winding, the primary winding extending from a first terminal to a second terminal; providing a capacitor connected between the first terminal and a power input terminal; providing a first switch having a first gate terminal, a first source terminal and a first drain terminal, the first drain terminal connected to the power input terminal; providing a second switch having a second gate terminal, a second source terminal and a second drain terminal, the second drain terminal connected to the second terminal and to the first source terminal; and sensing, by a controller circuit, a voltage from the first drain terminal to the first source terminal; comparing, by the controller circuit, the sensed voltage to a predetermined threshold; and when the sensed voltage exceeds the predetermined threshold, transitioning, by the controller circuit, the first switch from a first on-state to a first off-state, from the first off-state to a second on-state and from the second on-state to a second off-state.

In some embodiments, the overcurrent sensing circuit includes a voltage sensing circuit connected to the first drain terminal and to the first source terminal.

In some embodiments, the voltage sensing circuit is arranged to sense the voltage from the first drain terminal to the first source terminal, and generate a signal corresponding to the sensed voltage.

In some embodiments, the voltage sensing circuit is further arranged to transmit the signal to an isolator circuit.

In some embodiments, the isolator circuit is arranged to receive the signal and transmit it to the active discharge controller circuit.

In some embodiments, the method further includes transitioning, by the controller circuit, the first switch from the second off-state to a third on-state and from the third on-state to a third off-state.

In some embodiments, a circuit is disclosed. The circuit includes a transformer having a primary winding magnetically coupled to a secondary winding, the primary winding extending from a first terminal to a second terminal; a capacitor connected between the second terminal and a ground; a first switch having a first gate terminal, a first source terminal and a first drain terminal, the first drain terminal connected to the first terminal; a second switch having a second gate terminal, a second source terminal and a second drain terminal, the second drain terminal connected to a power input terminal and the second source terminal connected to the first terminal; and a controller circuit connected to the second terminal and arranged to: sense a voltage at the second terminal; compare the sensed voltage to a predetermined threshold; and in response to the sensed voltage exceeding the predetermined threshold, control a state of the first switch such that the first switch is transitioned from a first on-state to a first off-state, from the first off-state to a second on-state and from the second on-state to a second off-state.

In some embodiments, the second capacitor includes a first end and a second end, where the first end is connected to the second terminal and the second end is connected to the resistor.

### BRIEF DESCRIPTION OF THE DRAWINGS

FIG. 1 illustrates a simplified schematic of an asymmetric half-bridge flyback converter with high-side switch protection, according to some embodiments;

FIG. 2 is a simplified flowchart illustrating a method of operating a high side switch in its safe operating area (SOA) in an AHB circuit, according to some embodiments of the disclosure;

FIG. 3 illustrates graphs of voltages at various nodes in circuit of FIG. 1, according to some embodiments;

FIG. 4 is a simplified flowchart illustrating an open loop method of operating a high side switch in its safe operating area (SOA) in an AHB circuit, according to some embodiments of the disclosure;

FIG. 5 illustrates graphs of voltages at various nodes in circuit of FIG. 1 when the number of turn on/offs of Q1 is two, according to some embodiments;

FIG. 6 is a simplified flowchart illustrating a method of operating a high side switch in its safe operating area (SOA) in an AHB circuit within maximum on-time, according to some embodiments of the disclosure;

FIG. 7 illustrates graphs of voltages at various nodes in circuit of FIG. 1 when the active discharge mode may use maximum on-time of Q1 as a condition to exit the active discharge mode, according to some embodiments;

FIG. 8 illustrates details of a Q1 overcurrent detection circuit for a high-side resonant tank in an AHB circuit, according to some embodiments;

FIG. 9 illustrates details of a Q1 overcurrent detection circuit for a low-side resonant tank in an AHB circuit, according to some embodiments;

FIG. 10 illustrates details of a Q1 overcurrent detection circuit for a high-side resonant tank in an AHB circuit using a drain-source voltage of Q1, according to some embodiments;

FIG. 11 illustrates details of a Q1 overcurrent detection circuit for a low-side resonant tank in an AHB circuit using a drain-source voltage of Q1, according to some embodiments;

FIG. 12 illustrates details of a Q1 overcurrent detection circuit for a high-side resonant tank in an AHB circuit using sensing transformer, according to some embodiments; and

FIG. 13 illustrates details of a Q1 overcurrent detection circuit for a low-side resonant tank in an AHB circuit using a sense resistor, according to some embodiments.

### DETAILED DESCRIPTION

Circuits, devices and related techniques disclosed herein relate generally to electronic circuits. More specifically, circuits, devices and related techniques disclosed herein relate to circuits and methods of operating high side switches in their safe operating area (SOA) in switching regulators. In some embodiments, in an asymmetric half-bridge (AHB) circuit when an overcurrent (OC) condition in a high-side (Q1) switch is detected, Q1 may be turned off followed by Q1 being switched on and off at least once in the current switching cycle such that the resonant capacitor (Cr) can be discharged relatively efficiently. In this way, a voltage balance between a voltage across the resonant capacitor V_{Cr} and a voltage at the output of the AHB circuit can be achieved in a relatively short time.

In various embodiments, a controller circuit in an AHB converter can have a resonant tank overcurrent detection circuit, where the controller circuit can be arranged to detect an overcurrent condition in the resonant tank when Q1 turns on. The controller can then generate and transmit an overcurrent signal to a resonant capacitor active discharge control circuit. In response to the overcurrent signal, the resonant capacitor active discharge control circuit may turn off Q1 in order to keep it in its SOA. The resonant capacitor active discharge control circuit can then switch Q1 on and off at least once before the low-side switch (Q2) is turned back on. In this way, the resonant capacitor can be discharged relatively efficiently, thereby achieving a voltage balance between the voltage across the resonant capacitor V_{Cr} and the output voltage of the AHB circuit in a relatively short time period. Thus, the AHB circuit can return to steady state operation relatively quickly.

Embodiments of the disclosure can be used in AHB converter circuits with high-side and/or low-side resonant tanks. Further, circuits and techniques disclosed herein can be used with other switching regulator circuits such as, but not limited to, inductor-inductor-capacitor (LLC) half-bridge LLC converters, and active-clamp-flyback (ACF) converter circuits. Circuits and techniques disclosed herein can be used for detecting overcurrent conditions in Q1 switch of AHB circuits with high-side and low-side resonant tanks. Furthermore, circuits and techniques disclosed herein can be used for detecting overcurrent conditions in high-side switch of ACF and LLC circuits. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

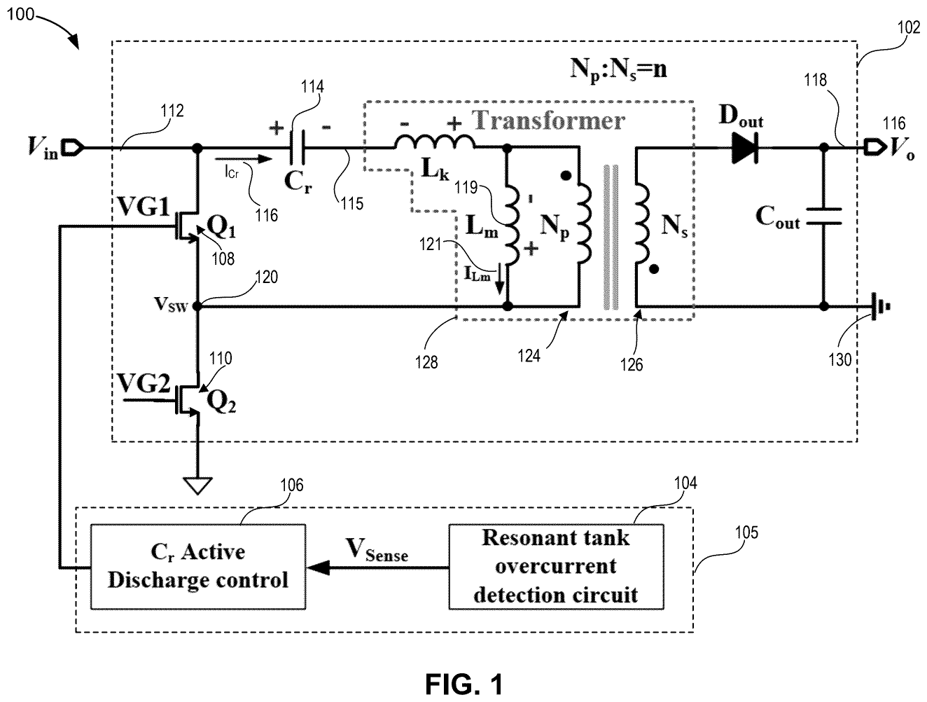

FIG. 1 illustrates a simplified schematic of an asymmetric half-bridge flyback converter with high-side switch protection, according to some embodiments. FIG. 1 illustrates a circuit 100 having an AHB converter 102 that includes a high-side switch 108 (Q1) and a low-side switch 110 (Q2). Q1 can be connected to Q2 at a switch node 120. Circuit 100 can include a controller circuit 105 that is arranged to keep Q1 operating in its safe operating area (SOA). The controller circuit 105 can include a resonant tank overcurrent detection circuit 104 and a resonant capacitor discharge control circuit 106. Circuit 100 can be arranged to operate such that Q1 is kept in its safe operating area (SOA). Circuit 100 can include an AHB flyback converter 102 connected to the resonant capacitor discharge control circuit 106. Circuit 100 can also include a resonant capacitor 114 that is connected to an input terminal 112 and to a drain terminal of Q1. The resonant tank overcurrent detection circuit 104 can be connected to the resonant capacitor discharge control circuit 106. The resonant tank overcurrent detection circuit 104 can be arranged to detect an overcurrent condition during the operation of circuit 100. The resonant capacitor discharge control circuit 106 can be connected to a gate terminal of Q1, where the resonant capacitor discharge control circuit 106 can control a conductivity state of Q1. A current flowing through the resonant capacitor 114 is current 116 (Icr). A current flowing through leakage inductance 119 (Lm) is current 121 (I_{Lm}).

Circuit 100 can further include a transformer 128 having a primary winding 124 and a secondary winding 126. The primary winding may extend from the input terminal 112 to the switch node 120. The secondary winding may extend from an output terminal 118 to a ground 130. Circuit 100 can be arranged to receive an input voltage Vin at the input terminal 112 and generate an output voltage Vo at the output terminal 118.

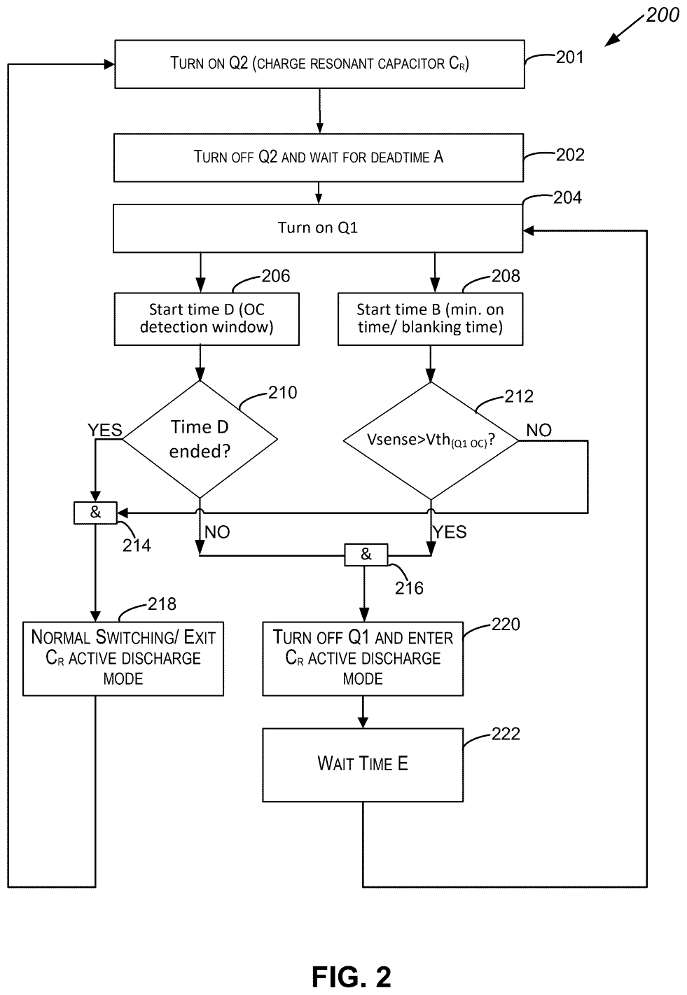

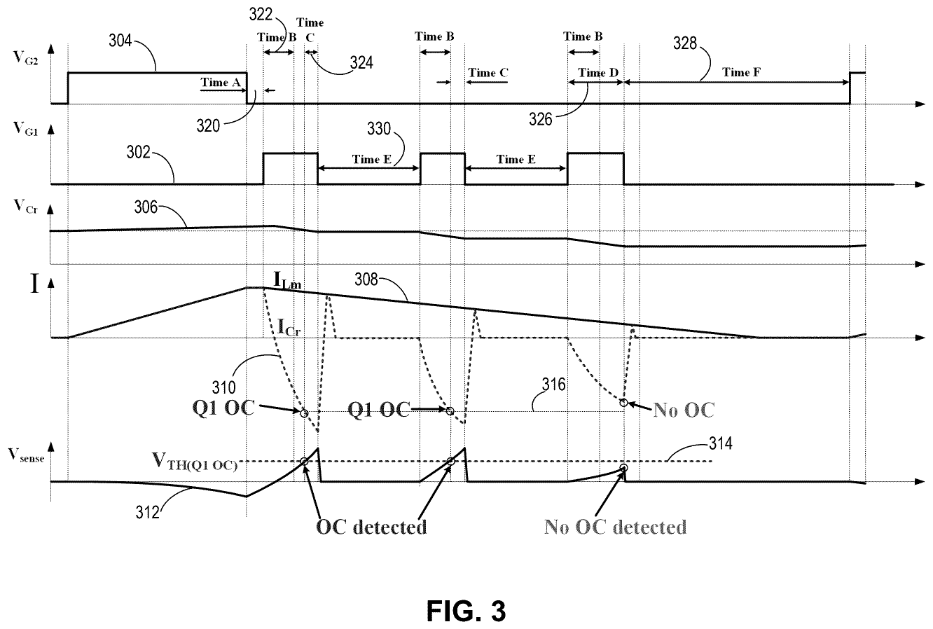

FIG. 2 is a simplified flowchart illustrating a method of operating a high side switch in its safe operating area (SOA) in an AHB circuit, according to some embodiments of the disclosure. As illustrated in FIG. 2, method 200 of operating a high side switch in its safe operating area (SOA) in an AHB circuit can include turning on Q2 (201), while during Q2 on time the resonant capacitor 114 can get charged. The method further includes turning off Q2 and waiting for deadtime period A to be completed (202). Referring to FIG. 3, deadtime A is a time period between the gate terminal of the Q2 going low and the gate terminal of Q1 going high. The method also includes turning on Q1 (204). The method additionally includes starting a timer D for overcurrent detection window (206). During time period D, if an overcurrent condition in Q1 is detected, then the Cr active discharge mode is activated where Q1 may be turned off followed by Q1 being switched on and off once in the current switching cycle.

The method also includes starting a timer B is for blanking time/minimum on time (208). The method further includes determining if time period D has ended (210). The method additionally includes determining if overcurrent condition in Q1 has occurred by determining if Vsense is greater than V_{TH(Q1 OC)} (212). In some embodiments, Vsense is a voltage at node 115. V_{TH(Q1 OC)} is a predetermined threshold voltage for Q1 overcurrent condition. Other methods can be used for determining the overcurrent condition of Q1 and are within the scope of this disclosure. The method also includes performing AND operation on the result of step 210 when time D has ended with result of step 212 when Vsense is not greater than V_{TH(Q1 OC)}. The method additionally includes performing AND operation on result of step 210 when time D has not ended with result of step 212 when Vsense is greater than V_{TH(Q1 OC)}. The results of step 214 can cause normal switching to continue (218). The results of step 216 can cause Q1 to turn off and the controller circuit 105 to enter resonant capacitor discharge active mode (220). The method further includes waiting for a time period E (222) and then turning on Q1 again (204). Using this repetitive process, Q1 can be turned on and off until the overcurrent condition has been removed. The method also includes turning on Q2 when normal switching is in progress (201).

It should be appreciated that the specific steps illustrated in FIG. 2 provide a particular method of operating a high side switch in its safe operating area (SOA) in an AHB circuit, according to an embodiment of the disclosure. Other sequences of steps may also be performed according to alternative embodiments. For example, alternative embodiments of the disclosure may perform the steps outlined above in a different order. Moreover, the individual steps illustrated in FIG. 2 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 3 illustrates graphs of voltages at various nodes in circuit 100, according to some embodiments. FIG. 3 shows the voltage 302 which is the voltage at the gate terminal of Q1, the voltage 304 at the gate terminal of Q2, and the voltage 306 being the voltage across the resonant capacitor 114. As shown in FIG. 3, when Q2 turns off and before Q1 turns on, there can be a deadtime 320 (labeled time A) before Q1 is turned on. FIG. 3 also shows the current 308 that flows through Lm and the current 310 that flows through the resonant capacitor 114. FIG. 3 further shows the voltage 312 that is a sensed voltage for detecting an overcurrent condition in Q1, and a Q1 overcurrent threshold voltage 314. FIG. 3 also shows a Q1 overcurrent threshold current 316. When Q1 is turned on, a time period 322 (labeled time B) used as a blanking time may be utilized to prevent spurious voltages. In some embodiments, time period B can be a minimum on-time for Q1 to ensure that spurious voltages are avoided.

When Q1 is on, the resonant tank overcurrent detection circuit 104 can sense the voltage 312 and compare it to the Q1 overcurrent threshold voltage 314. When the sensed voltage 312 exceeds the Q1 overcurrent threshold voltage 314, Q1 is commanded to turn off. Time period 324 (labeled time C) is a driver delay time, where Q1 turns off after time period C after the turn-off command is sent by the controller circuit to the driver. Time period 326 (labeled time D) is the overcurrent detection window, during which Q1 is monitored for an overcurrent conduction. If during time period D an overcurrent condition occurs, Q1 may be turned off followed by Q1 being switched on and off once in the current switching cycle. Time period 328 (labeled time F) is a time period (during the active resonant capacitor discharge) after the last turn on/off cycle of Q1 when the overcurrent condition no longer exists and before the turn-on of Q2. Time period 330 (labeled time E) is a time period between Q1 being turned on multiple times during the active resonant capacitor discharge mode.

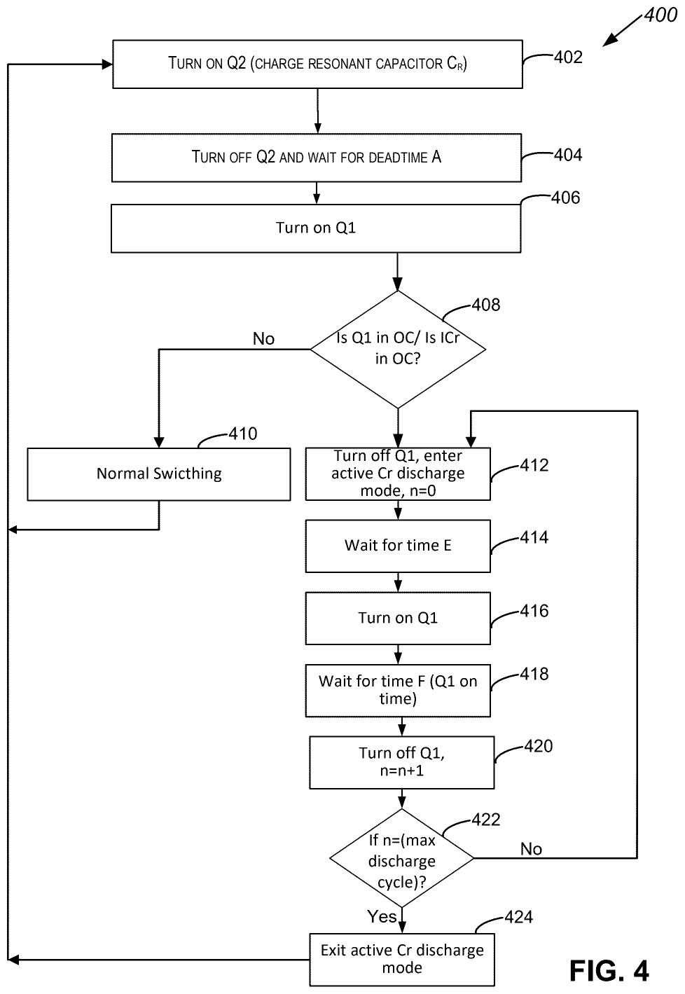

FIG. 4 is a simplified flowchart illustrating an open loop method of operating a high side switch in its safe operating area (SOA) in an AHB circuit, according to some embodiments of the disclosure. As illustrated in FIG. 4, method 400 of operating a high side switch in its safe operating area (SOA) in an AHB circuit can include turning on Q2 (402), where during Q2 on-time the resonant capacitor 114 can get charged. The method further includes turning off Q2 and waiting for deadtime period A to be completed (404). The method also includes turning on Q1 after completion of deadtime period A (406). The method further includes determining, during the time period when Q1 is on, if an overcurrent condition in Q1 is detected, and/or if the current in the resonant capacitor I_{cr} is in an overcurrent condition (408). If an overcurrent condition is not detected in step 408, then normal switching mode resumes (410), where Q2 can be turned on again (step 402).

If an overcurrent condition is detected in step 408, Q1 can be turned off (412), where circuit 100 can enter resonant capacitor active discharge mode for the current switching cycle. After Q1 has turned off in step 412, the method includes waiting for a time period E to be completed (414). After the time period E has completed, the method further includes turning on Q1 (416). After Q1 has turned on, Q1 may stay on for a time period F (step 418). In some embodiments, time period may be a fixed time period. Q1 can then be turned off (420). The method can also include determining if a maximum number of resonant capacitor discharge cycles has been completed by circuit 100 (422). If the number of resonant capacitor discharge cycles has not reached the maximum number, the method goes back to step 412 where Q1 is turned off again. If the number of resonant capacitor discharge cycles has reached the maximum number, the method proceeds to exit the active discharge mode and goes back to step 402 for the next switching cycle.

It should be appreciated that the specific steps illustrated in FIG. 4 provide a particular method of operating a high side switch in its safe operating area (SOA) in an AHB circuit, according to an embodiment of the disclosure. Other sequences of steps may also be performed according to alternative embodiments. For example, alternative embodiments of the disclosure may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

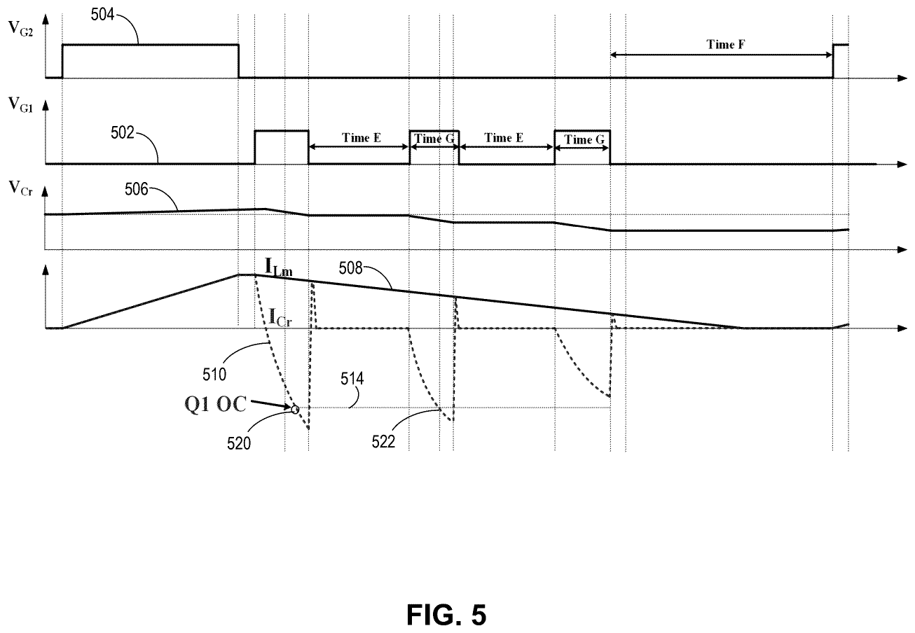

FIG. 5 illustrates graphs of voltages at various nodes in circuit 100 when the number of turn on/offs of Q1 is two, according to some embodiments. FIG. 5 shows the voltage 502 which is the voltage at the gate terminal of Q1, the voltage 504 at the gate terminal of Q2, and the voltage 506 being the voltage across the resonant capacitor 114. FIG. 5 also shows the current 508 that flows through Lm and the current 510 that flows through the resonant capacitor 114. FIG. 5 further shows the voltage 506 being the voltage across the resonant capacitor. FIG. 5 shows two OC conditions occurring at time period 520 and 522. Thus, Q1 is turned on and off twice before Q2 is turned back on. An overcurrent condition can be detected when the current in the resonant capacitor I_{cr} exceeds a predetermined current threshold 514. In some embodiments, the on-time of Q1 may be a fixed time period G. In various embodiments, circuit 100 may exit active Cr discharge mode, regardless of whether an overcurrent condition is detected.

Both methods 200 and 400 have similar steps for entering the Active Cr discharge Mode, i.e., both have similar steps up to detecting Q1 overcurrent condition. In method 400, after detecting the overcurrent condition, Q1 may switch n times, and each time it is turned on for a fixed duration (time period G), as shown in voltage graph 504 where n=2. A difference between methods 200 and 400 is that in method 400, the number of times Q1 switches is fixed, and even if an OC is still detected, Q1 may be forced to exit Active Cr discharge Mode, whereas in method 200, Q1 will keep switching until no OC is detected. In other words, method 400 is an open-loop control when OC is detected, while method 200 is a closed-loop control method.

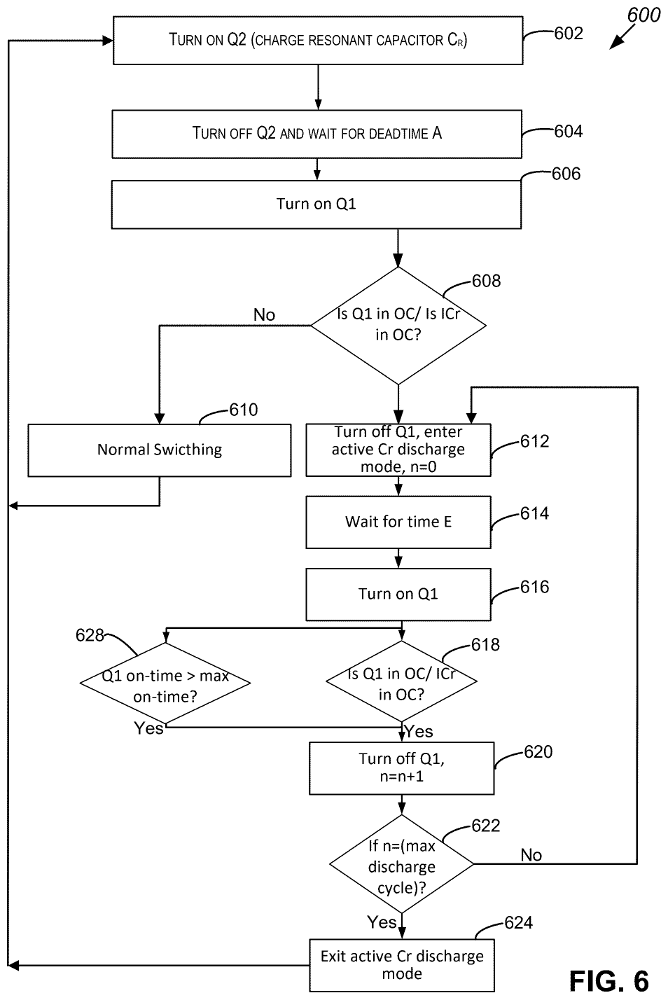

FIG. 6 is a simplified flowchart illustrating a method of operating a high side switch in its safe operating area (SOA) in an AHB circuit within maximum on-time, according to some embodiments of the disclosure. As illustrated in FIG. 6, method 600 of operating a high side switch in its safe operating area (SOA) in an AHB circuit can include turning on Q2 (602), where during Q2 on time the resonant capacitor 114 can get charged. The method further includes turning off Q2 and waiting for deadtime period A to be completed (604). The method also includes turning on Q1 after completion of deadtime period A (606). The method further includes determining, during the time period when Q1 is on, if an overcurrent condition in Q1 is detected, or if the current in the resonant capacitor I_{cr} is in an overcurrent condition (608). If an overcurrent condition is not detected in step 608, then normal switching mode resumes (610), where Q2 can be turned on again (step 602).

If an overcurrent condition is detected in step 608, Q1 can be turned off (612), where circuit 100 can enter resonant capacitor active discharge mode for the current switching cycle. After Q1 has turned off in step 612, the method includes waiting for a time period E to be completed (614). After the time period E has completed, the method further includes turning on Q1 (616). After Q1 has turned on, the method includes determining if Q1 is in overcurrent condition and/or I_{cr} is in overcurrent condition (618). The method also includes determining if Q1 on-time is greater than a maximum on-time (628). When the method determines that Q1 is in overcurrent condition and/or that I_{cr} is in overcurrent condition, Q1 can be turned off (620). Further, when the method determines that Q1 on-time is greater than a maximum on-time, Q1 can be turned off (620). The method can also include determining if a maximum number of resonant capacitor discharge cycles has been completed by circuit 100 (622). If the number of resonant capacitor discharge cycles has not reached the maximum number, the method goes back to step 612 where Q1 is turned off again. If the number of resonant capacitor discharge cycles has reached the maximum number, the method proceeds to exit the active discharge mode and goes back to step 602 for the next switching cycle.

It should be appreciated that the specific steps illustrated in FIG. 6 provide a particular method of operating a high side switch in its safe operating area (SOA) in an AHB circuit within maximum on-time, according to an embodiment of the disclosure. Other sequences of steps may also be performed according to alternative embodiments. For example, alternative embodiments of the disclosure may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

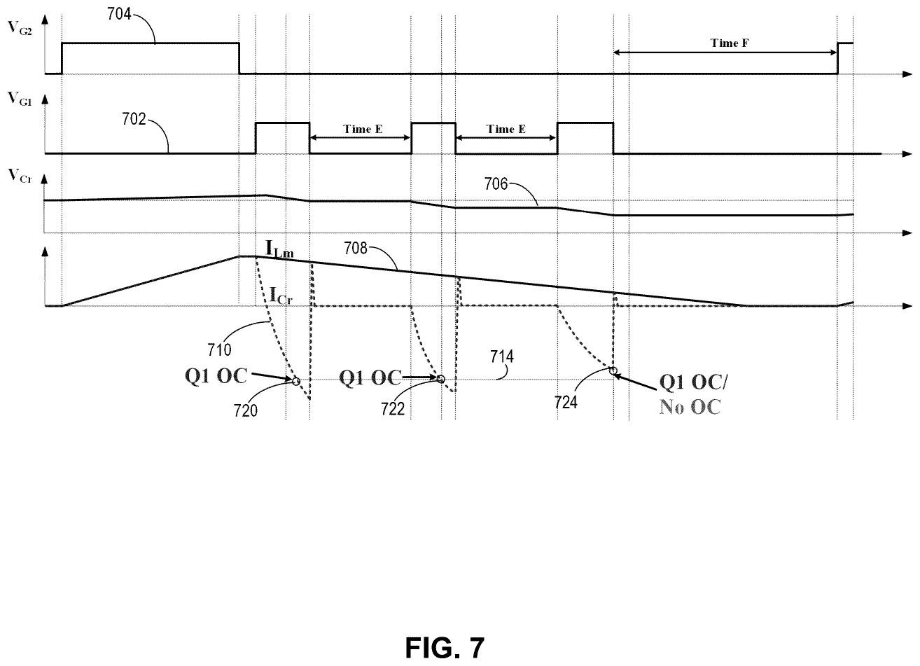

FIG. 7 illustrates graphs of voltages at various nodes in circuit 100 when the active discharge mode may use maximum on-time of Q1 as a condition to exit the active discharge mode, according to some embodiments. FIG. 7 shows voltage 702 which is the voltage at the gate terminal of Q1, the voltage 704 at the gate terminal of Q2, and the voltage 706 being the voltage across the resonant capacitor 114. FIG. 7 also shows the current 708 that flows through Lm and the current 710 that flows through the resonant capacitor 114. FIG. 7 further shows the voltage 706 being the voltage across the resonant capacitor. FIG. 7 shows overcurrent conditions at times 720 and 722. An overcurrent condition can be detected when the current in the resonant capacitor I_{Cr} exceeds a predetermined current threshold 714. In method 600, after entering Active Cr discharge Mode, Q1 may turn off after detecting an overcurrent condition or reaching the maximum Q1 on time. At time 724, there is no longer an OC condition.

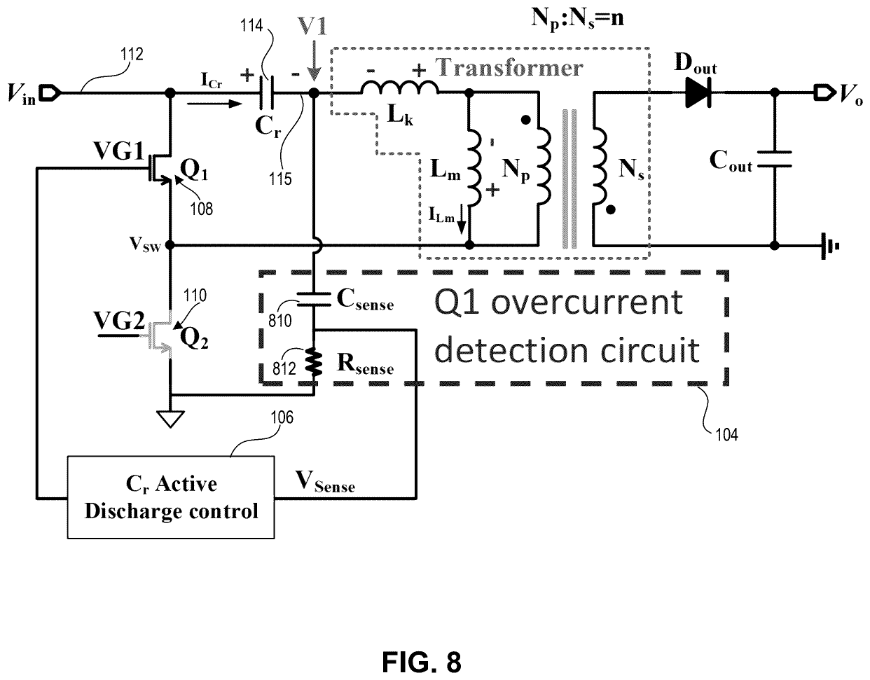

FIGS. 8-13 illustrate circuits and techniques for Q1 overcurrent detection, according to various embodiments of the disclosure. FIG. 8 illustrates details of a Q1 overcurrent detection circuit for a high-side resonant tank in an AHB circuit, according to some embodiments. FIG. 8 illustrates a circuit 100 with a Q1 overcurrent detection circuit 104. The Q1 overcurrent detection circuit 104 can include a sense capacitor 810 that is connected to node 115, and a sense resistor 812 that is connected to the sense capacitor 810 at one end and to ground at the other end. The Q1 overcurrent detection circuit 104 can be arranged to detect a Q1 overcurrent condition. Q1 may have a relatively weak current capability in the resonant tank, thus detection of Q1 overcurrent condition can result in detection of resonant tank overcurrent condition. In the illustrated embodiment:

$${V}_{sense} \approx - {I}_{Cr} {R}_{sense} \frac{{C}_{sense}}{{C}_{r}}$$

$${V}_{sense} > {V}_{TH ( Q 1 OC )} means {I}_{cr} < - {I}_{TH ( Q 1 OC )}$$

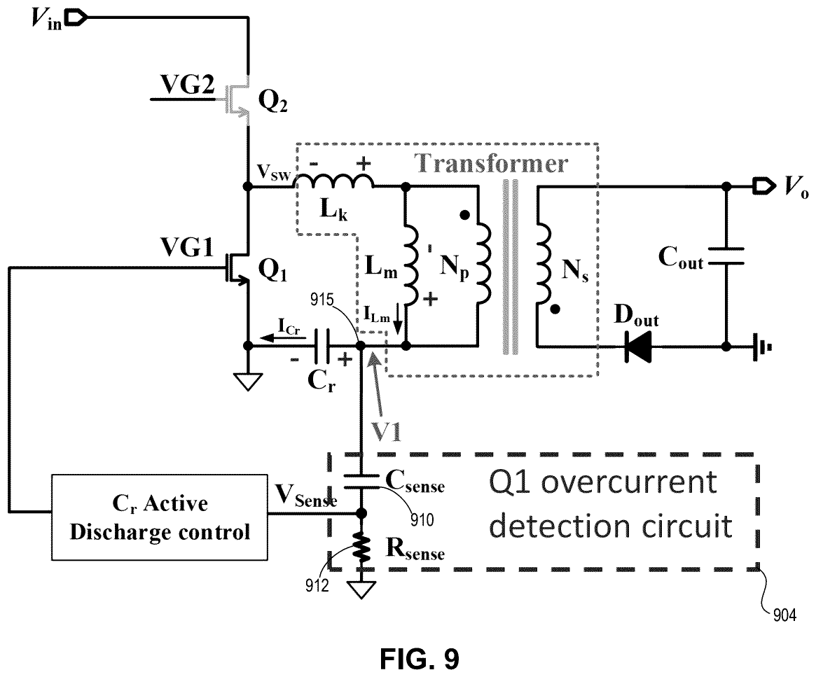

FIG. 9 illustrates details of a Q1 overcurrent detection circuit for a low-side resonant tank in an AHB circuit, according to some embodiments. FIG. 9 illustrates a Q1 overcurrent detection circuit 904. The Q1 overcurrent detection circuit 904 can include a sense capacitor 910 that is connected to node 915, and a sense resistor 912 that is connected to the sense capacitor 910 at one end and to ground at the other end. The Q1 overcurrent detection circuit 904 can be arranged to detect a Q1 overcurrent condition.

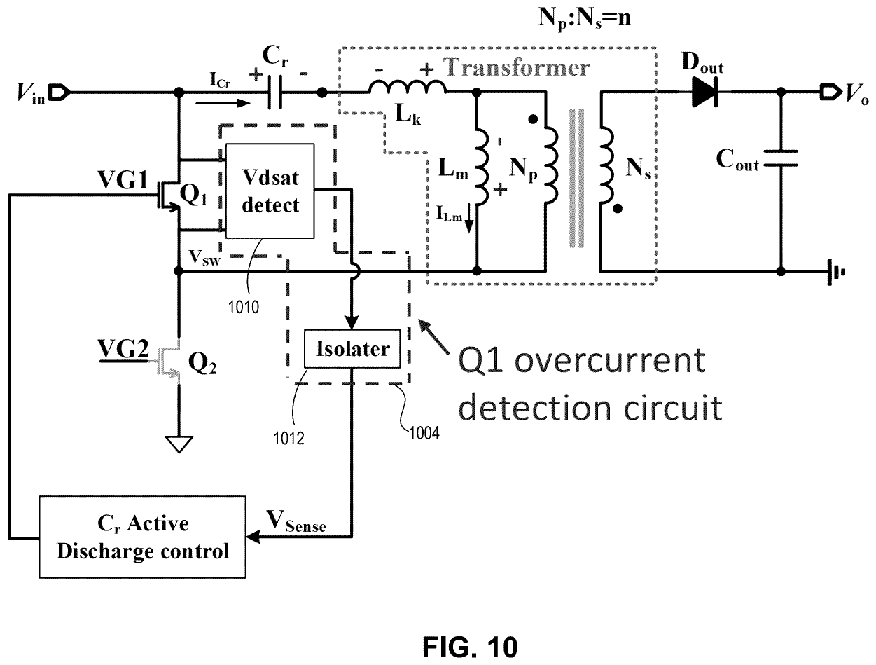

FIG. 10 illustrates details of a Q1 overcurrent detection circuit for a high-side resonant tank in an AHB circuit using a drain-source voltage of Q1, according to some embodiments. FIG. 10 illustrates a Q1 overcurrent detection circuit 1004. The Q1 overcurrent detection circuit 1004 can include a drain-source voltage detection circuit 1010 that is connected to a drain terminal and a source terminal of Q1. The drain-source voltage detection circuit 1010 can be connected to an isolator circuit 1012 that is connected to the resonant capacitor discharge control circuit 104. The drain-source voltage detection circuit 1010 can be arranged to sense a drain-source voltage of Q1 and transmit a corresponding signal to the isolator circuit 1012 when an overcurrent condition occurs. The isolator circuit 1012 can transmit the signal to the resonant capacitor discharge control circuit 104.

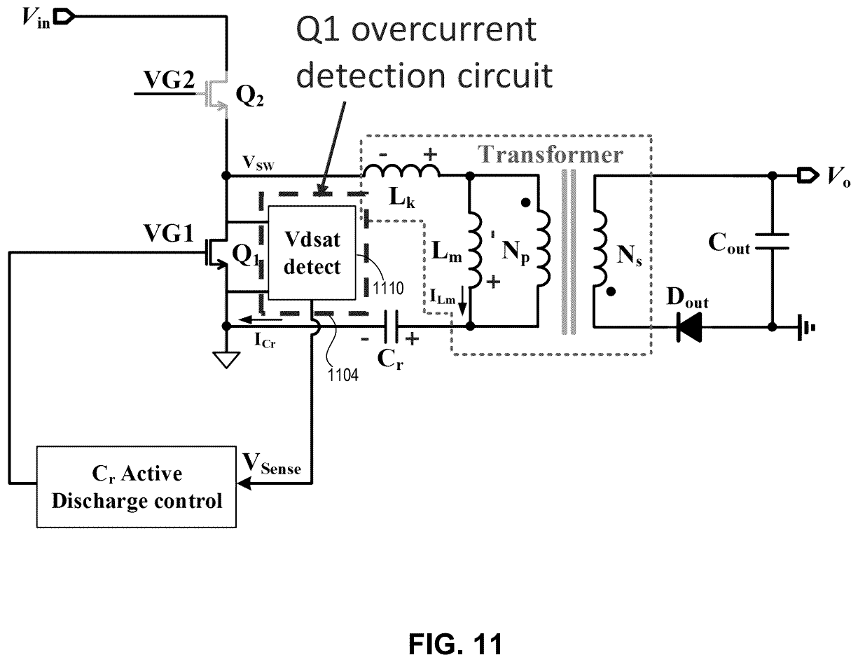

FIG. 11 illustrates details of a Q1 overcurrent detection circuit for a low-side resonant tank in an AHB circuit using a drain-source voltage of Q1, according to some embodiments. FIG. 10 illustrates a Q1 overcurrent detection circuit 1104. The Q1 overcurrent detection circuit 1104 can include a drain-source voltage detection circuit 1110 that is connected to a drain terminal and a source terminal of Q1. The drain-source voltage detection circuit can be arranged to sense a drain-source voltage of Q1 and transmit a corresponding signal to the resonant capacitor discharge control circuit.

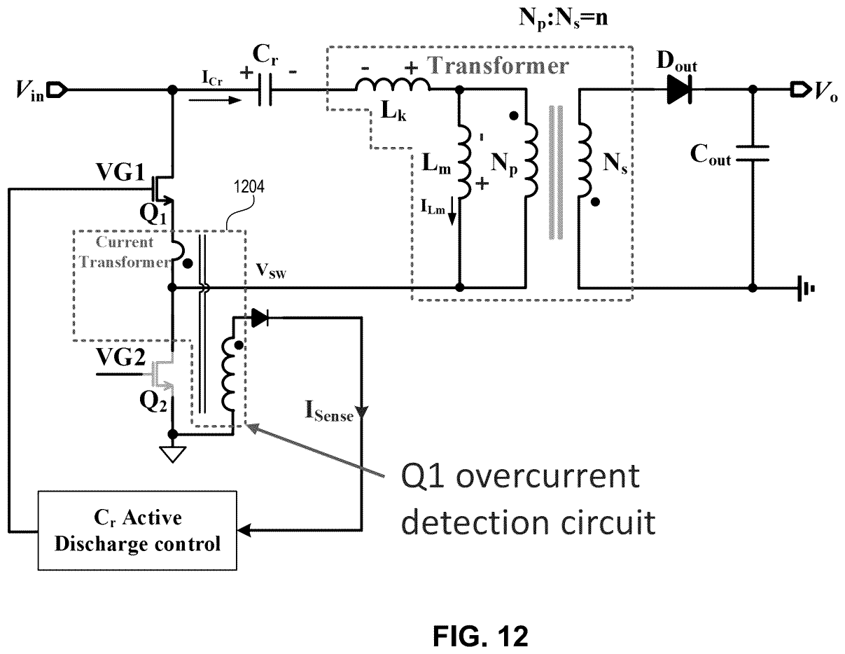

FIG. 12 illustrates details of a Q1 overcurrent detection circuit for a high-side resonant tank in an AHB circuit using sensing transformer, according to some embodiments. FIG. 12 illustrates a Q1 overcurrent detection circuit 1204. The Q1 overcurrent detection circuit 1204 can include a current transformer that is arranged to sense a current in Q1 and transmit a corresponding signal to the resonant capacitor discharge control circuit.

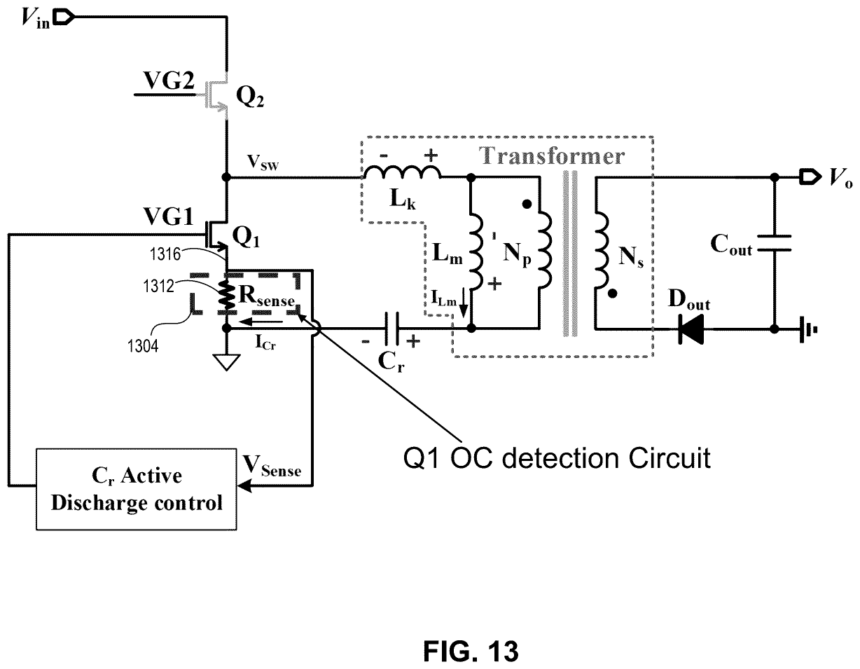

FIG. 13 illustrates details of a Q1 overcurrent detection circuit for a low-side resonant tank in an AHB circuit using a sense resistor, according to some embodiments. FIG. 13 illustrates a Q1 overcurrent detection circuit 1304. The Q1 overcurrent detection circuit 1304 can include a sense resistor 1312 that is connected to a source terminal of Q1. A voltage at the node 1316 that corresponds to the current flowing through Q1 can be sensed and transmitted to the resonant capacitor discharge control circuit.

In some embodiments, combination of the circuits and methods disclosed herein can be utilized to provide circuits and methods of operating high side switches in their safe operating area (SOA) in isolated DC-DC converter with resonant tank circuits such as, but not limited to, AHB, active/passive clamp flyback (ACF/PCF) converter circuits and inductor-inductor-capacitor (LLC) half-bridge LLC converters. Although circuits and methods are described and illustrated herein with respect to several particular configuration of an AHB converter circuit having a high-side resonant tank, embodiments of the disclosure are suitable for use with other power converter circuits such as, but not limited to, low-side resonant tank AHB and active/passive clamp flyback (ACF/PCF) converter circuits, and LLC circuits.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “and/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A circuit comprising:
a transformer having a primary winding magnetically coupled to a secondary winding, the primary winding extending from a first terminal to a second terminal;
a capacitor connected between the first terminal and a power input terminal;
a first switch having a first gate terminal, a first source terminal and a first drain terminal, the first drain terminal connected to the power input terminal;
a second switch having a second gate terminal, a second source terminal and a second drain terminal, the second drain terminal connected to the second terminal and to the first source terminal; and
a controller circuit connected to the first terminal and arranged to:
sense a voltage at the first terminal;
compare the sensed voltage to a predetermined threshold; and
control a state of the first switch such that when the sensed voltage exceeds the predetermined threshold, the state of the first switch is transitioned from a first on-state to a first off-state, from the first off-state to a second on-state and from the second on-state to a second off-state.

2. The circuit of claim 1, wherein the controller circuit comprises an overcurrent sensing circuit connected to an active discharge controller circuit.

3. The circuit of claim 2, wherein the capacitor is a first capacitor, and wherein the overcurrent sensing circuit comprises a second capacitor connected to a resistor.

4. The circuit of claim 3, wherein the second capacitor includes a first end and a second end, and wherein the first end is connected to the first terminal and the second end is connected to the resistor.

5. The circuit of claim 2, wherein the controller circuit is further arranged to control the state of the first switch such that after transition from the second on-state to a second off-state, the first switch is transitioned from the second off-state to a third on-state and from the third on-state to a third off-state.

6. The circuit of claim 5, wherein a time duration of the second on-state is equal to a time duration of the third on-state.

7. A method of operating a circuit, the method comprising:
providing a transformer having a primary winding magnetically coupled to a secondary winding, the primary winding extending from a first terminal to a second terminal;
providing a capacitor connected between the first terminal and a power input terminal;
providing a first switch having a first gate terminal, a first source terminal and a first drain terminal, the first drain terminal connected to the power input terminal;
providing a second switch having a second gate terminal, a second source terminal and a second drain terminal, the second drain terminal connected to the second terminal and to the first source terminal; and
sensing, by a controller circuit, a voltage from the first drain terminal to the first source terminal;
comparing, by the controller circuit, the sensed voltage to a predetermined threshold; and
when the sensed voltage exceeds the predetermined threshold, transitioning, by the controller circuit, the first switch from a first on-state to a first off-state, from the first off-state to a second on-state and from the second on-state to a second off-state.

8. The method of claim 7, wherein the controller circuit comprises an overcurrent sensing circuit connected to an active discharge controller circuit.

9. The method of claim 8, wherein the overcurrent sensing circuit comprises a voltage sensing circuit connected to the first drain terminal and to the first source terminal.

10. The method of claim 9, wherein the voltage sensing circuit is arranged to sense the voltage from the first drain terminal to the first source terminal, and generate a signal corresponding to the sensed voltage.

11. The method of claim 10, wherein the voltage sensing circuit is further arranged to transmit the signal to an isolator circuit.

12. The method of claim 11, wherein the isolator circuit is arranged to receive the signal and transmit it to the active discharge controller circuit.

13. The method of claim 7, further comprising transitioning, by the controller circuit, the first switch from the second off-state to a third on-state and from the third on-state to a third off-state.

14. The method of claim 13, wherein a time duration of the second on-state is equal to a time duration of the third on-state.

15. A circuit comprising:
a transformer having a primary winding magnetically coupled to a secondary winding, the primary winding extending from a first terminal to a second terminal;
a capacitor connected between the second terminal and a ground;
a first switch having a first gate terminal, a first source terminal and a first drain terminal, the first drain terminal connected to the first terminal;
a second switch having a second gate terminal, a second source terminal and a second drain terminal, the second drain terminal connected to a power input terminal and the second source terminal connected to the first terminal; and
a controller circuit connected to the second terminal and arranged to:
sense a voltage at the second terminal;
compare the sensed voltage to a predetermined threshold; and
in response to the sensed voltage exceeding the predetermined threshold, control a state of the first switch such that the first switch is transitioned from a first on-state to a first off-state, from the first off-state to a second on-state and from the second on-state to a second off-state.

16. The circuit of claim 15, wherein the controller circuit comprises an overcurrent sensing circuit connected to an active discharge controller circuit.

17. The circuit of claim 16, wherein the capacitor is a first capacitor, and wherein the overcurrent sensing circuit comprises a second capacitor connected to a resistor.

18. The circuit of claim 17, wherein the second capacitor includes a first end and a second end, and wherein the first end is connected to the second terminal and the second end is connected to the resistor.

19. The circuit of claim 16, wherein the controller circuit is further arranged to control the state of the first switch such that after transition from the second on-state to a second off-state, the first switch is transitioned from the second off-state to a third on-state and from the third on-state to a third off-state.

20. The circuit of claim 19, wherein a time duration of the second on-state is equal to a time duration of the third on-state.
